(19) United States
(12) Patent Application Publication
(10) Pub. No.: US 2020/0137632 A1
(43) Pub. Date: Apr. 30, 2020

(54) SERVICE QUALITY MANAGEMENT METHOD AND APPARATUS

(71) Applicant: BEIJING XIAOMI MOBILE SOFTWARE CO., LTD., BEIJING (CN)

(72) Inventor: Wei HONG, Beijing (CN)

(73) Assignee: BEIJING XIAOMI MOBILE SOFTWARE CO., LTD., BEIJING (CN)

(21) Appl. No.: 16/729,383

(22) Filed: Dec. 28, 2019

Related U.S. Application Data
(63) Continuation of application No. PCT/CN2017/094922, filed on Jul. 28, 2017.

(51) Int. Cl. H04W 28/24; H04W 48/18; H04W 76/15

(52) U.S. Cl. CPC H04W 28/24; H04W 76/15; H04W 48/18

(57) ABSTRACT

A service quality management method includes: receiving an attach request initiated by a controllable device after a boot operation is completed, the attach request being used for requesting attachment to a core network; and separately establishing a signaling bearer and a data bearer for the controllable device according to the attach request so as to attach the controllable device to the core network.

### CROSS-REFERENCE TO RELATED APPLICATION

The present application is a continuation of International Application No. PCT/CN2017/094922 filed on Jul. 28, 2017, the disclosure of which is hereby incorporated by reference in its entirety.

### BACKGROUND

With the rapid development, cost reduction, and functional maturation of controllable device technologies, the use of controllable devices is becoming more and more popular. For example, the use of unmanned aerial vehicles (UAVs) in aerial photography, agriculture, plant protection, etc., has greatly expanded the application of the controllable devices.

### SUMMARY

The present disclosure generally relates to the field of communication technologies, and more specifically to a method and an apparatus for service quality management.

Embodiments of the present disclosure provide a method and an apparatus for service quality management.

According to a first aspect of the embodiments of the present disclosure, there is provided a method for service quality management. Applied to a core network in a cellular network, the method includes:

receiving an attach request initiated by a controllable device after a boot operation is completed, the attach request being used for requesting attachment to the core network; and

separately establishing a signaling bearer and a data bearer for the controllable device according to the attach request so as to attach the controllable device to the core network.

In some embodiments, the separately establishing a signaling bearer and a data bearer for the controllable device according to the attach request includes:

configuring a quality class identification (QCI) corresponding to the signaling bearer according to the attach request and at least one of:

a QCI corresponding to a real-time game service;

a QCI corresponding to an inter-vehicle communication service; or

a predefined first QCI, the first QCI being the QCI of a service quality of the signaling bearer established for the controllable device.

In some embodiments, a service quality parameter corresponding to the first QCI includes at least one of:

a type that is a resource type having a guaranteed bit rate;

a packet delay budget within a delay scope ranging from 50 milliseconds to 100 milliseconds; or

a packet loss rate ranging from 10⁻⁴ to 10⁻³.

In some embodiments, before the separately establishing a signaling bearer and a data bearer for the controllable device according to the attach request, the method further includes:

adding a target note into the QCI corresponding to the signaling bearer, the target note being used to identify that the current QCI is used to transmit information corresponding to the controllable device.

In some embodiments, the separately establishing a signaling bearer and a data bearer for the controllable device according to the attach request includes:

configuring a quality class identification (QCI) corresponding to the data bearer according to the attach request and a predefined second QCI, the second QCI being a QCI of a service quality of the data bearer established for the controllable device.

In some embodiments, a service quality parameter corresponding to the second QCI includes at least one of:

a type that is a resource type having guaranteed bit rate or non-guaranteed bit rate;

a packet delay budget within a delay scope ranging from 100 milliseconds to 300 milliseconds; or

a packet loss rate ranging from 10⁻⁶ to 10⁻⁵.

In some embodiments, before the separately establishing a signaling bearer and a data bearer for the controllable device according to the attach request, the method further includes:

adding a target note into the QCI corresponding to the data bearer, the target note being used to identify that the current QCI is used to transmit information corresponding to the controllable device.

In some embodiments, the controllable device is an unmanned aerial vehicle.

According to a second aspect of the embodiments of the present disclosure, there is provided an apparatus for service quality management. Applied to a core network in a cellular network, the apparatus includes:

a receiving module, configured to receive an attach request initiated by a controllable device after a boot operation is completed, the attach request being used for requesting attachment to the core network; and

an execution module, configured to separately establish a signaling bearer and a data bearer for the controllable device according to the attach request so as to attach the controllable device to the core network.

In some embodiments, the execution module includes:

a first configuration sub-module, configured to configure a quality class identification (QCI) corresponding to the signaling bearer according to the attach request and at least one of:

a QCI corresponding to a real-time game service;

a QCI corresponding to an inter-vehicle communication service; or

a predefined first QCI, the first QCI being the QCI of a service quality of the signaling bearer established for the controllable device.

In some embodiments, a service quality parameter corresponding to the first QCI includes at least one of:

a type that is a resource type having guaranteed bit rate;

a packet delay budget within a delay scope ranging from 50 milliseconds to 100 milliseconds; or

a packet loss rate ranging from 10⁻⁴ to 10⁻³.

In some embodiments, the apparatus further includes:

a first adding module, configured to add a target note into the QCI corresponding to the signaling bearer, the target note being used to identify that the current QCI is used to transmit information corresponding to the controllable device.

In some embodiments, the execution module includes:

a second configuration sub-module, configured to configure a quality class identification (QCI) corresponding to the data bearer according to the attach request and a predefined second QCI, the second QCI being a QCI of a service quality of the data bearer established for the controllable device.

In some embodiments, a service quality parameter corresponding to the second QCI includes at least one of:

a type that is a resource type having guaranteed bit rate or non-guaranteed bit rate;

a packet delay budget within a delay scope ranging from 100 milliseconds to 300 milliseconds; or

a packet loss rate ranging from 10⁻⁶ to 10⁻⁵.

In some embodiments, the apparatus further includes:

a second adding module, configured to add a target note into the QCI corresponding to the data bearer, the target note being used to identify that the current QCI is used to transmit information corresponding to the controllable device.

In some embodiments, the controllable device is an unmanned aerial vehicle.

According to a third aspect of the embodiments of the present disclosure, there is provided an apparatus for service quality management. Applied to a core network in a cellular network, the apparatus includes:

a processor, and

a memory configured to store executable instructions of the processor.

The processor is configured to:

receive an attach request initiated by a controllable device after a boot operation is completed, the attach request being used for requesting attachment to the core network; and

separately establish a signaling bearer and a data bearer for the controllable device according to the attach request so as to attach the controllable device to the core network.

It is to be understood that the above general description and the detailed description below are merely exemplary and explanatory, and do not limit the present disclosure.

### BRIEF DESCRIPTION OF THE DRAWINGS

The accompanying drawings, which are incorporated in and constitute a part of this disclosure, illustrate embodiments conforming to the present disclosure and, together with the specification, serve to explain the principles of the present disclosure.

FIG. 1 illustrates a schematic diagram of a service quality management scenario according to some embodiments;

FIG. 2 illustrates a flowchart of a method for service quality management according to some embodiments;

FIG. 3 illustrates a flowchart of another method for service quality management according to some embodiments;

FIG. 4 illustrates a flowchart of still another method for service quality management according to some embodiments;

FIG. 5 illustrates a block diagram of an apparatus for service quality management according to some embodiments;

FIG. 6 illustrates a block diagram of another apparatus for service quality management according to some embodiments;

FIG. 7 illustrates a block diagram of still another apparatus for service quality management according to some embodiments;

FIG. 8 illustrates a block diagram of still another apparatus for service quality management according to some embodiments;

FIG. 9 illustrates a block diagram of still another apparatus for service quality management according to some embodiments; and

FIG. 10 illustrates a schematic structural diagram of an apparatus for service quality management according to some embodiments of the present disclosure.

### DETAILED DESCRIPTION

Exemplary embodiments will be described in detail herein, examples of which are illustrated in the accompanying drawings. The following description refers to the same or similar elements in the different figures unless otherwise indicated. The implementations set forth in the following description of exemplary embodiments do not represent all implementations consistent with the present disclosure. Instead, they are merely examples of apparatuses and methods consistent with some aspects related to the present disclosure as recited in the appended claims.

The terms used in the present disclosure are only for the purpose of description of specific embodiments, and are not intended to limit the present disclosure. As used in the present disclosure and in the appended claims, the singular forms “a/an,” “said” and “the” intend to also include the plural form, unless the context clearly dictates otherwise. It should also be understood that the term “and/or” used herein refers to and include any or all possible combinations of one or more listed items.

It should be understood that terms such as “first,” “second,” “third” and the like may be used herein for description of information. However, the information should not be restricted to these terms. These terms are only intended to distinguish among information of the same type. For example, without departing from the scope of the present disclosure, a first information can also be referred to as a second information, similarly, a second information can also be referred to as a first information. Depending on the context, the term “if” used herein can be interpreted as “when,” “while” or “in response to determining”.

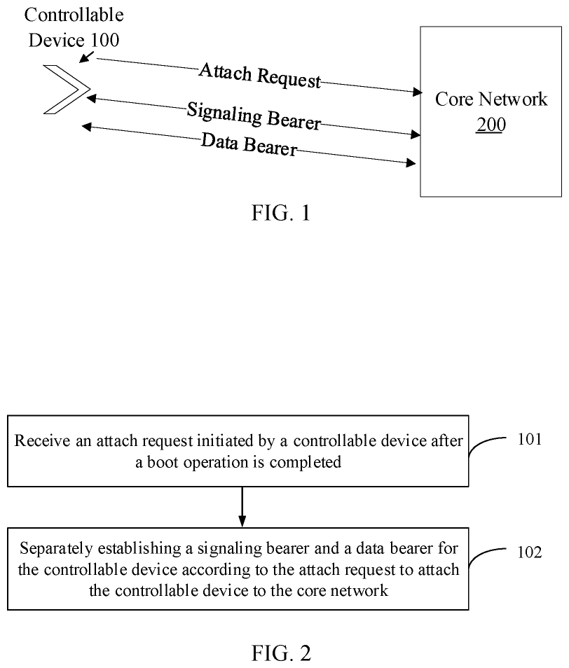

A scenario of service quality management provided by an embodiment of the present disclosure is as shown in FIG. 1. A controllable device 100 is an unmanned aerial vehicle in this example. After a boot operation is completed, the controllable device 100 may initiate an attach request, which is used for requesting attachment to a core network 200 in a cellular network. After receiving the attach request, the core network 200 may separately establish a signaling bearer and a data bearer for the controllable device 100 according to the attach request.

Signaling may be transmitted between the controllable device 100 and the core network 200 via the signaling bearer, and the signaling may be used to control the controllable device 100 to perform corresponding operations. Data may be transmitted between the controllable device 100 and the core network 200 via the data bearer. In this way, it is ensured that the signaling and the data of the controllable device can be normally transmitted in the cellular network, and it is ensured the service quality of communications between the cellular network and the controllable device.

An embodiment of the present disclosure provides a method for service quality management. Referring to FIG. 2, a flowchart of a method for service quality management is illustrated according to some embodiments. This method may be used in a core network in a cellular network and may include following steps:

in Step 101, receiving an attach request initiated by a controllable device after a boot operation is completed;

wherein, the attach request is used for requesting attachment to the core network;

in Step 102, separately establishing a signaling bearer and a data bearer for the controllable device according to the attach request so as to attach the controllable device to the core network.

In the above embodiment, the controllable device may initiate an attach request to the core network in the cellular network after a boot operation is completed, the attach request being used for requesting attachment to the core network. After receiving the attach request, the core network separately establishes a signaling bearer and a data bearer for the controllable device according to the attach request so as to attach the controllable device to the core network. Through the above procedures, the core network in the cellular network may separately establish a dedicated bearer for signaling and data of the controllable device, thereby ensuring that the controllable device can be attached to the core network in the cellular network. Based on signaling transmission between the cellular network and the controllable device through a dedicated signaling bearer and data transmission between the cellular network and the controllable device through a dedicated data bearer, it is ensured that signaling and data of the controllable device can be transmitted normally in the cellular network. In addition, because of higher communication quality of the cellular network, the service quality of communication between the cellular network and the controllable device can be ensured by the dedicated signaling bearer and the dedicated data bearer established between the controllable device and the cellular network.

For the Step 101, the controllable device may be, for example, an unmanned aerial vehicle. After a boot operation is completed, the unmanned aerial vehicle may initiate an attach request to a core network in a cellular network by a base station, the attach request being used for requesting attachment to the core network. The core network directly receives the attach request.

For the Step 102, the core network may separately establish the signaling bearer and the data bearer for the unmanned aerial vehicle by:

configuring a quality class identification (QCI) corresponding to the signaling bearer according to the attach request and at least one of:

a QCI corresponding to a real-time game service;

a QCI corresponding to an inter-vehicle communication service; or

a predefined first QCI, the first QCI being the QCI of a service quality of the signaling bearer established for the controllable device.

After receiving the attach request initiated by the controllable device, the core network may configure the QCI corresponding to the signaling bearer for the unmanned aerial vehicle according to the attach request and the QCI corresponding to the real-time game service. That is, the core network may configure the QCI corresponding to the real-time game service as the QCI corresponding to the signaling bearer of the unmanned aerial vehicle.

In some embodiments, the core network may also configure the QCI corresponding to the signaling bearer for the unmanned aerial vehicle according to the attach request and the QCI corresponding to the inter-vehicle communication service. The core network may configure the QCI corresponding to the inter-vehicle communication service as the QCI corresponding to the signaling bearer of the unmanned aerial vehicle. In the related technologies, the QCI corresponding to the real-time service game is the same as the QCI corresponding to the inter-vehicle communication service, wherein values of the QCIs are both 3. In the embodiments of the present disclosure, the QCI corresponding to the signaling bearer may be configured for the unmanned aerial vehicle according to the QCI corresponding to the real-time service game and the QCI corresponding to the inter-vehicle communication service.

In the related technologies, the service quality parameters corresponding to the QCI corresponding to the real-time service game and the QCI corresponding to the inter-vehicle communication service include at least one of a resource type, a priority level, a packet delay budget, or a packet loss rate, as shown in Table 1.

TABLE 1

| | | | Packet | Packet | |
|---|---|---|---|---|---|
| | Resource | Priority | Delay | Loss | Example |
| QCI | Type | Level | Budget | Rate | Service |
| 3 | GBR | 3 | 50 | 10⁻³ | Real-Time Game |
| | (Guaranteed | | milli- | | Inter-Vehicle |
| | Bit Rate) | | seconds | | Communication |
| | | | | | Service |

Of course, the core network may also configure the QCI corresponding to the signaling bearer for the unmanned aerial vehicle according to the attach request and the predefined first QCI. The first QCI is the QCI of a service quality of the signaling bearer established for the controllable device such as the unmanned aerial vehicle.

In some embodiments, a service quality parameter corresponding to the first QCI includes at least one of:

a type that is a resource type having guaranteed bit rate;

a packet delay budget within a delay scope ranging from 50 milliseconds to 100 milliseconds; or

a packet loss rate ranging from 10⁻⁴ to 10⁻³.

In the embodiments of the present disclosure, the core network may configure the first QCI as the QCI corresponding to the signaling bearer of the unmanned aerial vehicle.

Considering it is needed to control the unmanned aerial vehicle in real time, the requirements for transmission of the signaling are relatively high. The resource type corresponding to the first QCI may be GBR (Guaranteed Bit Rate), which refers to the minimum bit rate bearer guaranteed by the system. That is, even in the case of tight network resources, the corresponding bit rate can be maintained.

In addition, the packet delay budget corresponding to the first QCI may be shorter, for example, within a delay scope ranging from 50 milliseconds to 100 milliseconds. The packet loss rate may be controlled to be within a scope from 10⁻⁴ to 10⁻³.

That is, when the core network establishes a dedicated signaling bearer for the unmanned aerial vehicle, the QCI corresponding to the signaling bearer may adopt the QCI corresponding to the real-time game service, or the QCI corresponding to the inter-vehicle communication service, or the first QCI described above. The core network in the cellular network may establish a dedicated signaling bearer for the controllable device, thereby ensuring that the signaling of the controllable device can be normally transmitted in the cellular network through the dedicated signaling bearer. In addition, the QCI corresponding to the signaling bearer may adopt any one of the above QCIs, such that the signaling communication between the cellular network and the controllable device is endowed with a higher service quality, thereby ensuring the service quality of communication between the cellular network and the controllable device.

In the embodiments of the present disclosure, when the core network establishes a data bearer for the controllable device according to the attach request, the QCI corresponding to the data bearer may be configured according to the attach request and the predefined second QCI. The second QCI may be the QCI of the service quality of the signaling bearer established for the controllable device. Of course, the controllable device may be an unmanned aerial vehicle.

In some embodiments, a service quality parameter corresponding to the second QCI may include at least one of:

a type that is a resource type having guaranteed bit rate or non-guaranteed bit rate;

a packet delay budget within a delay scope ranging from 100 milliseconds to 300 milliseconds; or

a packet loss rate ranging from 10⁻⁶ to 10⁻⁵.

Considering the data transmission between the cellular network and the unmanned aerial vehicle is as below: the unmanned aerial vehicle feeds back the collected data to the cellular network, but the feedback of the data does not need to be real-time. Therefore, the requirements for transmission of the data bearer may be lower. The resource type corresponding to the second QCI may be GBR (Guaranteed Bit Rate) or may be Non-GBR (Non-Guaranteed Bit Rate). The Non-GBR refers to a bit rate where a service (or bearer) needs to bear a reduced rate in the case of network congestion. Since the Non-GBR bearer does not need to occupy fixed network resources, the Non-GBR bearer may be established for a long time.

In addition, the packet delay budget corresponding to the second QCI may be longer, for example, within a delay scope ranging from 100 milliseconds to 300 milliseconds. The packet loss rate may be controlled to be within a scope from 10⁻⁶ to 10⁻⁵.

That is, when the core network establishes a dedicated data bearer for the unmanned aerial vehicle, the QCI corresponding to the data bearer may adopt the second QCI. The core network in the cellular network may establish a dedicated data bearer for the controllable device to transmit data of the controllable device, thereby ensuring that the data of the controllable device can be normally transmitted in the cellular network. In addition, the QCI corresponding to the data bearer may adopt the above second QCI, such that the data communication between the cellular network and the controllable device is endowed with a higher service quality, thereby ensuring the service quality of communication between the cellular network and the controllable device.

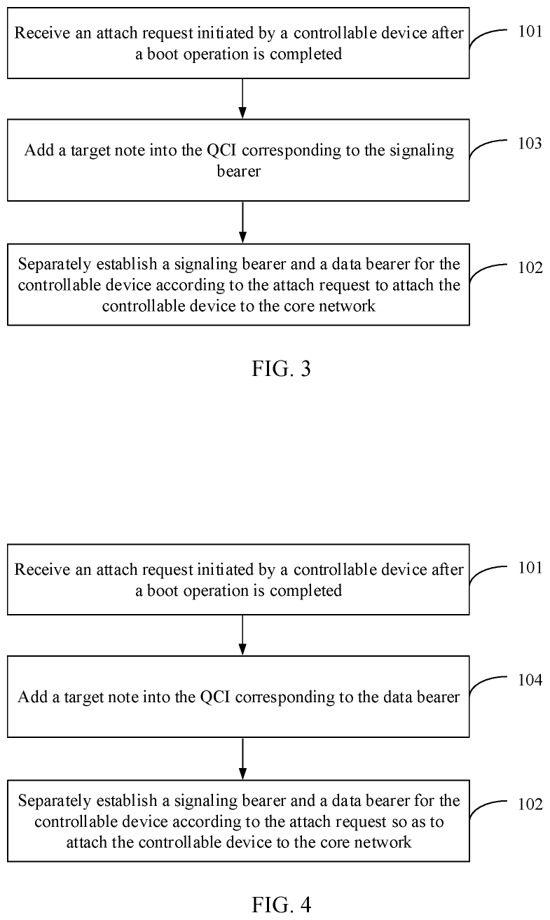

In an embodiment, to ensure that the QCI corresponding to the signaling bearer can be used to transmit the information corresponding to the controllable device, as shown in FIG. 3, which illustrates a flowchart of another method for service quality management according to the embodiment as shown in FIG. 2, before executing the Step 102, the method further includes the following step.

In Step 103, a target note is added into the QCI corresponding to the signaling bearer, wherein the target note is used to identify that the current QCI may be used to transmit information corresponding to the controllable device.

In the embodiments of the present disclosure, before performing the above Step 102, the target note needs to be added into the QCI corresponding to the signaling bearer, so as to identify that the current QCI may be used to transmit the information corresponding to the controllable device. The information corresponding to the controllable device may include: common information for interacting with the controllable device, and control information for controlling the controllable device to perform corresponding operations, etc.

In the related technologies, the QCI corresponding to the real-time game service and the QCI corresponding to the inter-vehicle communication service have the same value of 3. Two notes have been defined in the QCI, including a NOTE 3 and a NOTE 14, which are respectively corresponding to the information corresponding to the real-time game service and the information corresponding to the inter-vehicle communication service, as shown in Table 2.

TABLE 2

| | | | Packet | Packet | |
|---|---|---|---|---|---|
| | Resource | Priority | Delay | Loss | Example |
| QCI | Type | Level | Budget | Rate | Service |
| 3 | GBR | 3 | 50 | 10⁻³ | Real-Time Game |
| (NOTE 3, | | | milli- | | Inter-Vehicle |
| NOTE 14) | | | seconds | | Communication |
| | | | | | Service |

In the embodiments of the present disclosure, if the QCI corresponding to the signaling bearer needs to adopt the QCI corresponding to the real-time game service or the QCI corresponding to the inter-vehicle communication service, a new target note such as NOTE15 may be added into Table 2 to identify that the current QCI may be used to transmit the information corresponding to the controllable device, as shown in Table 3.

TABLE 3

| | | | Packet | Packet | |
|---|---|---|---|---|---|
| | Resource | Priority | Delay | Loss | Example |
| QCI | Type | Level | Budget | Rate | Service |
| 3 | GBR | 3 | 50 | 10⁻³ | Real-Time Game |
| (NOTE 3, | | | milli- | | Inter-Vehicle |
| NOTE 14, | | | seconds | | Communication |
| NOTE 15) | | | | | Service |

NOTE 15:
this QCI may be used to transmit the information corresponding to the controllable device.

If the QCI corresponding to the signaling bearer needs to adopt the first QCI, the value of the first QCI may be a value absent from the related technologies. For example, the value of the first QCI may be M. Service quality parameters corresponding to the QCI into which the target note has been added may be as shown in Table 4.

TABLE 4

| | | Packet | Packet | |
|---|---|---|---|---|
| | Resource | Delay | Loss | Example |
| QCI | Type | Budget | Rate | Service |
| M | GBR | 50 | 10⁻⁴ to | Services |
| (NOTE 15) | | milli- | 10⁻³ | corresponding |
| | | seconds | | to the |
| | | to 100 | | controllable |
| | | milli- | | device |
| | | seconds | | |

NOTE 15:
this QCI may be used to transmit the information corresponding to the controllable device.

After the target note is added into the QCI corresponding to the signaling bearer, this indicates that the current QCI may be used to transmit the information corresponding to the controllable device. The core network may continue to perform the Step 102 of configuring a quality class identification (QCI) corresponding to the signaling bearer according to the attach request and at least one of:

a QCI corresponding to a real-time game service;

a QCI corresponding to an inter-vehicle communication service; or

a predefined first QCI, the first QCI being the QCI of a service quality of the signaling bearer established for the controllable device.

In the above embodiment, a target note is added into the QCI corresponding to the signaling bearer, such that the current QCI may be used to transmit the information corresponding to the controllable device. Subsequently, the QCI corresponding to the signaling bearer may be configured by the QCI into which the target note is added, such that the signaling communication between the cellular network and the controllable device is endowed with a higher service quality.

In some embodiments, to ensure that the QCI corresponding to the data bearer can be used to transmit the information corresponding to the controllable device, as shown in FIG. 4, which illustrates a flowchart of another method for service quality management according to the embodiment as shown in FIG. 2, before executing the Step 102, the method further includes the following step.

In Step 104, a target note is added into the QCI corresponding to the data bearer, wherein the target note is used to identify that the current QCI may be used to transmit the information corresponding to the controllable device.

In the embodiments of the present disclosure, before performing the above Step 102, a target note needs to be added into the QCI corresponding to the data bearer, so as to identify that the current QCI may be used to transmit the information corresponding to the controllable device. The information corresponding to the controllable device may include: common information for interacting with the controllable device, and control information for controlling the controllable device to perform corresponding operations, etc.

If the QCI corresponding to the data bearer adopts the second QCI, the value of the second QCI may be a value absent from the related technologies. For example, the value of the second QCI may be N. Service quality parameters corresponding to the second QCI into which the target note has been added may be as shown in Table 5.

TABLE 5

| | | Packet | Packet | |
|---|---|---|---|---|
| | Resource | Delay | Loss | Example |
| QCI | Type | Budget | Rate | Service |
| N | GBR or | 100 | 10⁻⁶ to | Services |
| (NOTE 15) | Non-GBR | milli- | 10^{-s} | corresponding |
| | | seconds | | to the |
| | | to 300 | | controllable |
| | | milli- | | device |
| | | seconds | | |

NOTE 15:
this QCI may be used to transmit the information corresponding to the controllable device.

After the target note is added into the QCI corresponding to the data bearer, this indicates that the current QCI may be used to transmit the information corresponding to the controllable device. The core network may continue to perform the Step 102 of configuring a quality class identification (QCI) corresponding to the data bearer according to the attach request and any one of following items.

In the above embodiments, a target note needs to be added into the QCI corresponding to the data bearer, wherein the target note is used to identify that the current QCI may be used to transmit the information corresponding to the controllable device. By adding the target note, the current QCI is allowed to transmit the information corresponding to the controllable device, and then the QCI corresponding to the data bearer may be configured by the QCI into which the target note is added, such that the data communication between the cellular network and the controllable device is endowed with a higher service quality.

It should be explained that, for a brief description, the foregoing method examples are described as a combination of a series of motions. However, those skilled in the art should know that the present disclosure is not limited by sequences of the motions described. This is because some blocks may be performed by using other sequences or be performed simultaneously in accordance with the present disclosure.

In addition, those skilled in the art should also learn that the embodiments described in the specification are preferred embodiments, and involved motions and modules are not necessary for the present disclosure.

Corresponding to the foregoing embodiments of an application function implementation method, the present disclosure also provides an application function implementation apparatus and corresponding embodiments thereof.

FIG. 5 illustrates a block diagram of an apparatus for service quality management according to some embodiments. Used in a core network, the apparatus includes:

a receiving module 210, configured to receive an attach request initiated by a controllable device after a boot operation is completed, the attach request being used for requesting attachment to the core network; and

an execution module 220, configured to separately establish a signaling bearer and a data bearer for the controllable device according to the attach request so as to attach the controllable device to the core network.

In the embodiments of the present disclosure, the controllable device may initiate an attach request to the core network in the cellular network after a boot operation is completed, the attach request being used for requesting attachment to the core network. After receiving the attach request, the core network establishes a signaling bearer and a data bearer separately for the controllable device according to the attach request so as to attach the controllable device to the core network. Through the above procedures, the core network in the cellular network may separately establish a dedicated bearer for signaling and data of the controllable device, thereby ensuring that the controllable device can be attached to the core network in the cellular network. Based on signaling transmission between the cellular network and the controllable device through a dedicated signaling bearer and data transmission between the cellular network and the controllable device through a dedicated data bearer, it is ensured that signaling and data of the controllable device can be normally transmitted in the cellular network. In addition, because of higher communication quality of the cellular network, the service quality of communication between the cellular network and the controllable device can be ensured by the dedicated signaling bearer and the dedicated data bearer established between the controllable device and the cellular network.

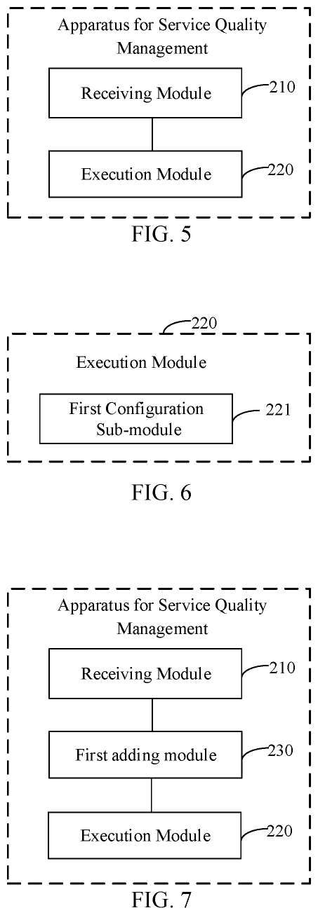

Reference may be made to FIG. 6, which is a block diagram of another apparatus for service quality management illustrated based on the embodiment as shown in FIG. 5. The execution module 220 includes:

a first configuration sub-module 221, configured to configure a quality class identification (QCI) corresponding to the signaling bearer according to the attach request and at least one of:

a QCI corresponding to a real-time game service;

a QCI corresponding to an inter-vehicle communication service; or

a predefined first QCI, the first QCI being the QCI of a service quality of the signaling bearer established for the controllable device.

In the above embodiments, alternatively, the core network may establish a QCI corresponding to the signaling bearer for the controllable device according to the attach request and at least one of: a QCI corresponding to a real-time game service; a QCI corresponding to an inter-vehicle communication service; or a predefined first QCI, wherein the first QCI is the QCI of a service quality of the signaling bearer established for the controllable device. Through the above procedures, the core network in the cellular network may establish a dedicated signaling bearer for the controllable device, thereby ensuring that the signaling of the controllable device can be normally transmitted in the cellular network through the dedicated signaling bearer. In addition, the QCI corresponding to the signaling bearer may adopt any one of the above QCIs, such that the signaling communication between the cellular network and the controllable device is endowed with a higher service quality, thereby ensuring the service quality of communication between the cellular network and the controllable device.

In some embodiments, a service quality parameter corresponding to the first QCI includes at least one of:

a type that is a resource type having guaranteed bit rate;

a packet delay budget within a delay scope ranging from 50 milliseconds to 100 milliseconds; or

a packet loss rate ranging from 10⁻⁴ to 10⁻³.

Reference may be made to FIG. 7, which is a block diagram of another apparatus for service quality management illustrated based on the embodiment as shown in FIG. 5. The apparatus further includes:

a first adding module 230, configured to add a target note into the QCI corresponding to the signaling bearer, the target note being used to identify that the current QCI is used to transmit information corresponding to the controllable device.

In the above embodiments, the core network in the cellular network adds a target note into the QCI corresponding to the signaling bearer, wherein the target note is used to identify that the current QCI is used to transmit information corresponding to the controllable device. By adding the target note, the current QCI is allowed to transmit the information corresponding to the controllable device, and then the QCI corresponding to the signaling bearer may be configured by the QCI into which the target note is added, such that the signaling communication between the cellular network and the controllable device is endowed with a higher service quality.

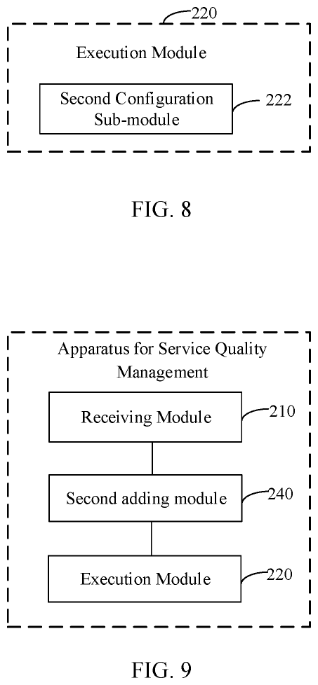

Reference is made to FIG. 8, which is a block diagram of another apparatus for service quality management illustrated based on the embodiment as shown in FIG. 5. The execution module 220 includes:

a second configuration sub-module 222, configured to configure a quality class identification (QCI) corresponding to the data bearer according to the attach request and a predefined second QCI, the second QCI being a QCI of a service quality of the data bearer established for the controllable device.

In the above embodiments, the core network may establish a QCI corresponding to the signaling bearer for the controllable device according to the attach request and a predefined second QCI, the second QCI being a QCI of a service quality of the data bearer established for the controllable device. Through the above procedures, the core network in the cellular network may establish a dedicated data bearer for the controllable device to transmit data of the controllable device, thereby ensuring that the data of the controllable device can be normally transmitted in the cellular network. In addition, the QCI corresponding to the data bearer may adopt the above second QCI, such that the data communication between the cellular network and the controllable device is endowed with a higher service quality, thereby ensuring the service quality of communication between the cellular network and the controllable device.

In some embodiments, a service quality parameter corresponding to the second QCI includes at least one of:

a type that is a resource type having guaranteed bit rate or non-guaranteed bit rate;

a packet delay budget within a delay scope ranging from 100 milliseconds to 300 milliseconds; or

a packet loss rate ranging from 10⁻⁶ to 10⁻⁵.

Reference is made to FIG. 9, which is a block diagram of another apparatus for service quality management illustrated based on the embodiment as shown in FIG. 5. The apparatus further includes:

a second adding module 240, configured to add a target note into the QCI corresponding to the data bearer, the target note being used to identify that the current QCI is used to transmit information corresponding to the controllable device.

In the above embodiments, the core network in the cellular network adds a target note into the QCI corresponding to the data bearer, wherein the target note is used to identify that the current QCI is used to transmit information corresponding to the controllable device. By adding the target note, the current QCI is allowed to transmit the information corresponding to the controllable device, and then the QCI corresponding to the signaling bearer may be configured by the QCI into which the target note is added, such that the data communication between the cellular network and the controllable device is endowed with a higher service quality.

In some embodiments, the controllable device is an unmanned aerial vehicle.

After receiving the attach request initiated by the unmanned aerial vehicle, the core network in the cellular network may separately establish a dedicated signaling bearer and a dedicated data bearer for the unmanned aerial vehicle to attach the unmanned aerial vehicle to the core network. Through the above procedures, the unmanned aerial vehicle is attached to the core network in the cellular network. Based on signaling transmission between the cellular network and the unmanned aerial vehicle through the dedicated signaling bearer and data transmission between the cellular network and the unmanned aerial vehicle through the dedicated data bearer, it is ensured that signaling and data of the unmanned aerial vehicle can be normally transmitted in the cellular network. In addition, because of higher communication quality of the cellular network, the service quality of communication between the cellular network and the unmanned aerial vehicle can be ensured by the dedicated signaling bearer and the dedicated data bearer established between the unmanned aerial vehicle and the cellular network. For the apparatus embodiment, it basically corresponds to the method embodiments, and thus the relevant parts can be referred to the description of the method embodiments. The apparatus embodiments set forth above are merely exemplary, wherein units described as detached parts can be or not be detachable physically; parts displayed as units can be or not be physical units, i.e., either located at the same place, or distributed on a plurality of network units. Modules can be selected in part or in whole according to the actual needs for realization of solutions of the present disclosure. It is conceivable and executable for those of ordinary skill in the art without creative labor.

The various device components, modules, units, blocks, or portions may have modular configurations, or are composed of discrete components, but nonetheless can be referred to as “modules” in general. In other words, the “components,” “modules,” “blocks,” “portions,” or “units” referred to herein may or may not be in modular forms.

Correspondingly, the present disclosure also provides a computer-readable storage medium, which stores computer instructions, wherein the computer instructions are configured to execute any one of the above methods for service quality management.

Correspondingly, the present disclosure also provides an apparatus for service quality management. Applied to a core network in a cellular network, the apparatus includes:

a processor, and

a memory configured to store executable instructions of the processor.

The processor is configured to:

receive an attach request initiated by a controllable device after a boot operation is completed, the attach request being used for requesting attachment to the core network; and

separately establish a signaling bearer and a data bearer for the controllable device according to the attach request so as to attach the controllable device to the core network.

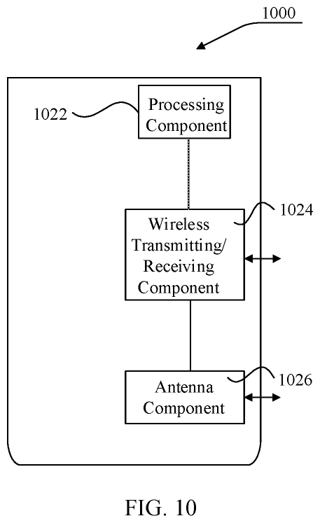

As shown in FIG. 10, a schematic structural diagram of an apparatus 1000 for service quality management is illustrated according to some embodiments. The apparatus 1000 may be provided as the core network in the cellular network. Referring to FIG. 10, the apparatus 1000 includes a processing component 1022, a wireless transmitting/receiving component 1024, an antenna component 1026, and a signal processing portion peculiar to a wireless interface. The processing component 1022 may further include one or more processors.

One processor of the processing component 1022 may be configured to:

receive an attach request initiated by a controllable device after a boot operation is completed, the attach request being used for requesting attachment to the core network; and

separately establish a signaling bearer and a data bearer for the controllable device according to the attach request so as to attach the controllable device to the core network.

Various embodiments of the present disclosure can have one or more of the following advantages.

In some embodiments of the present disclosure, the controllable device may initiate an attach request to the core network in the cellular network after a boot operation is completed, the attach request being used for requesting attachment to the core network. After receiving the attach request, the core network separately establishes a signaling bearer and a data bearer for the controllable device according to the attach request so as to attach the controllable device to the core network. Through the above procedures, the core network in the cellular network may separately establish a dedicated bearer for signaling and data of the controllable device, thereby ensuring that the controllable device can be attached to the core network in the cellular network. Based on signaling transmission between the cellular network and the controllable device through a dedicated signaling bearer and data transmission between the cellular network and the controllable device through a dedicated data bearer, it is ensured that the signaling and data of the controllable device can be normally transmitted in the cellular network. In addition, because of higher communication quality of the cellular network, the service quality of communication between the cellular network and the controllable device can be ensured by the dedicated signaling bearer and the dedicated data bearer established between the controllable device and the cellular network.

In some embodiments of the present disclosure, alternatively, the core network may establish a QCI corresponding to the signaling bearer for the controllable device according to the attach request and at least one of: a QCI corresponding to a real-time game service; a QCI corresponding to an inter-vehicle communication service; or a predefined first QCI, wherein the first QCI is the QCI of a service quality of the signaling bearer established for the controllable device. Through the above procedures, the core network in the cellular network may establish a dedicated signaling bearer for the controllable device, thereby ensuring that the signaling of the controllable device can be normally transmitted in the cellular network through the dedicated signaling bearer. In addition, the QCI corresponding to the signaling bearer may adopt any one of the above QCIs, such that the signaling communication between the cellular network and the controllable device is endowed with a higher service quality, thereby ensuring the service quality of communication between the cellular network and the controllable device.

In some embodiments of the present disclosure, alternatively, the core network may configure a QCI corresponding to the signaling bearer for the controllable device according to the attach request and a predefined second QCI, wherein the second QCI is a QCI of a service quality of the data bearer established for the controllable device. Through the above procedures, the core network in the cellular network may establish a dedicated data bearer for the controllable device to transmit data of the controllable device, thereby ensuring that the data of the controllable device can be normally transmitted in the cellular network. In addition, the QCI corresponding to the data bearer may adopt the above second QCI, such that the data communication between the cellular network and the controllable device is endowed with a higher service quality, thereby ensuring the service quality of communication between the cellular network and the controllable device.

In some embodiments of the present disclosure, the core network in the cellular network needs to separately add a target note into the QCI corresponding to the signaling bearer and the QCI corresponding to the data bearer, wherein the target note is used to identify that the current QCI is used to transmit information corresponding to the controllable device. By adding the target note, the current QCI is allowed to transmit the information corresponding to the controllable device, and then the QCI corresponding to the signaling bearer and the QCI corresponding to the data bearer may be separately configured by the QCI into which the target note is added, such that the signaling communication and the data communication between the cellular network and the controllable device are endowed with a higher service quality.

In some embodiments of the present disclosure, the controllable device may be an unmanned aerial vehicle. After receiving the attach request initiated by the unmanned aerial vehicle, the core network in the cellular network may separately establish a dedicated signaling bearer and a dedicated data bearer for the unmanned aerial vehicle to attach the unmanned aerial vehicle to the core network. Through the above procedures, the unmanned aerial vehicle is attached to the core network in the cellular network. Based on signaling transmission between the cellular network and the unmanned aerial vehicle through the dedicated signaling bearer and data transmission between the cellular network and the unmanned aerial vehicle through the dedicated data bearer, it is ensured that signaling and data of the unmanned aerial vehicle can be normally transmitted in the cellular network. In addition, because of higher communication quality of the cellular network, the service quality of communication between the cellular network and the unmanned aerial vehicle can be ensured by the dedicated signaling bearer and the dedicated data bearer established between the unmanned aerial vehicle and the cellular network.

Other implementation solutions of the present disclosure will be apparent to those skilled in the art from consideration of the specification and practice of the present disclosure. This disclosure is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

In the present disclosure, the terms “installed,” “connected,” “coupled,” “fixed” and the like shall be understood broadly, and can be either a fixed connection or a detachable connection, or integrated, unless otherwise explicitly defined. These terms can refer to mechanical or electrical connections, or both. Such connections can be direct connections or indirect connections through an intermediate medium. These terms can also refer to the internal connections or the interactions between elements. The specific meanings of the above terms in the present disclosure can be understood by those of ordinary skill in the art on a case-by-case basis.

In the description of the present disclosure, the terms “one embodiment,” “some embodiments,” “example,” “specific example,” or “some examples,” and the like can indicate a specific feature described in connection with the embodiment or example, a structure, a material or feature included in at least one embodiment or example. In the present disclosure, the schematic representation of the above terms is not necessarily directed to the same embodiment or example.

Moreover, the particular features, structures, materials, or characteristics described can be combined in a suitable manner in any one or more embodiments or examples. In addition, various embodiments or examples described in the specification, as well as features of various embodiments or examples, can be combined and reorganized.

In some embodiments, the control and/or interface software or app can be provided in a form of a non-transitory computer-readable storage medium having instructions stored thereon is further provided. For example, the non-transitory computer-readable storage medium can be a ROM, a CD-ROM, a magnetic tape, a floppy disk, optical data storage equipment, a flash drive such as a USB drive or an SD card, and the like.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium can be tangible.

The operations described in this disclosure can be implemented as operations performed by a data processing apparatus on data stored on one or more computer-readable storage devices or received from other sources.

The devices in this disclosure can include special purpose logic circuitry, e.g., an FPGA (field-programmable gate array), or an ASIC (application-specific integrated circuit). The device can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The devices and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and it can be deployed in any form, including as a stand-alone program or as a portion, component, subroutine, object, or other portion suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more portions, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA, or an ASIC.

Processors or processing circuits suitable for the execution of a computer program include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented with a computer and/or a display device, e.g., a VR/AR device, a head-mount display (HMD) device, a head-up display (HUD) device, smart eyewear (e.g., glasses), a CRT (cathode-ray tube), LCD (liquid-crystal display), OLED (organic light emitting diode), or any other monitor for displaying information to the user and a keyboard, a pointing device, e.g., a mouse, trackball, etc., or a touch screen, touch pad, etc., by which the user can provide input to the computer.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components.

The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination.

Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

As such, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing can be utilized.

It is intended that the specification and embodiments be considered as examples only. Other embodiments of the disclosure will be apparent to those skilled in the art in view of the specification and drawings of the present disclosure. That is, although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the example embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

It should be understood that “a plurality” or “multiple” as referred to herein means two or more. “And/or,” describing the association relationship of the associated objects, indicates that there may be three relationships, for example, A and/or B may indicate that there are three cases where A exists separately, A and B exist at the same time, and B exists separately. The character “/” generally indicates that the contextual objects are in an “or” relationship.

In the present disclosure, it is to be understood that the terms “lower,” “upper,” “under” or “beneath” or “underneath,” “above,” “front,” “back,” “left,” “right,” “top,” “bottom,” “inner,” “outer,” “horizontal,” “vertical,” and other orientation or positional relationships are based on example orientations illustrated in the drawings, and are merely for the convenience of the description of some embodiments, rather than indicating or implying the device or component being constructed and operated in a particular orientation. Therefore, these terms are not to be construed as limiting the scope of the present disclosure.

Moreover, the terms “first” and “second” are used for descriptive purposes only and are not to be construed as indicating or implying a relative importance or implicitly indicating the number of technical features indicated. Thus, elements referred to as “first” and “second” may include one or more of the features either explicitly or implicitly.

In the present disclosure, a first element being “on” a second element may indicate direct contact between the first and second elements, without contact, or indirect geometrical relationship through one or more intermediate media or layers, unless otherwise explicitly stated and defined. Similarly, a first element being “under,” “underneath” or “beneath” a second element may indicate direct contact between the first and second elements, without contact, or indirect geometrical relationship through one or more intermediate media or layers, unless otherwise explicitly stated and defined.

Some other embodiments of the present disclosure can be available to those skilled in the art upon consideration of the specification and practice of the various embodiments disclosed herein. The present application is intended to cover any variations, uses, or adaptations of the present disclosure following general principles of the present disclosure and include the common general knowledge or conventional technical means in the art without departing from the present disclosure. The specification and examples can be shown as illustrative only, and the true scope and spirit of the disclosure are indicated by the following claims.

1. A method for service quality management, the method being applied to a core network in a cellular network, and the method comprising:
receiving an attach request initiated by a controllable device after a boot operation is completed, the attach request being used for requesting attachment to the core network; and
separately establishing a signaling bearer and a data bearer for the controllable device according to the attach request to attach the controllable device to the core network.

2. The method according to claim 1, wherein the separately establishing the signaling bearer and the data bearer for the controllable device according to the attach request comprises:
configuring a quality class identification (QCI) corresponding to the signaling bearer according to the attach request and at least one of:
a QCI corresponding to a real-time game service;
a QCI corresponding to an inter-vehicle communication service; or
a predefined first QCI, the first QCI being the QCI of a service quality of the signaling bearer established for the controllable device.

3. The method according to claim 2, wherein a service quality parameter corresponding to the first QCI comprises at least one of:
a type that is a resource type having guaranteed bit rate;
a packet delay budget within a delay scope ranging from 50 milliseconds to 100 milliseconds; or
a packet loss rate ranging from 10⁻⁴ to 10⁻³.

4. The method according to claim 2, wherein, before the separately establishing the signaling bearer and the data bearer for the controllable device according to the attach request, the method further comprises:
adding a target note into the QCI corresponding to the signaling bearer, the target note being used to identify that the current QCI is used to transmit information corresponding to the controllable device.

5. The method according to claim 1, wherein the separately establishing the signaling bearer and the data bearer for the controllable device according to the attach request comprises:
configuring a quality class identification (QCI) corresponding to the data bearer according to the attach request and a predefined second QCI, the second QCI being a QCI of a service quality of the data bearer established for the controllable device.

6. The method according to claim 5, wherein a service quality parameter corresponding to the second QCI comprises at least one of:
a type that is a resource type having guaranteed bit rate or non-guaranteed bit rate;
a packet delay budget within a delay scope ranging from 100 milliseconds to 300 milliseconds; or
a packet loss rate ranging from 10⁻⁶ to 10⁻⁵.

7. The method according to claim 5, wherein before the separately establishing the signaling bearer and the data bearer for the controllable device according to the attach request, the method further comprises:
adding a target note into the QCI corresponding to the data bearer, the target note being used to identify that the current QCI is used to transmit information corresponding to the controllable device.

8. The method according to claim 1, wherein the controllable device is an unmanned aerial vehicle.

9. An apparatus for service quality management, the apparatus being applied to a core network in a cellular network, and the apparatus comprising:
a processor, and
a memory configured to store instructions executable by the processor;
wherein the processor is configured to:
receive an attach request initiated by a controllable device after a boot operation is completed, the attach request being used for requesting attachment to the core network; and
separately establish a signaling bearer and a data bearer for the controllable device according to the attach request to attach the controllable device to the core network.

10. The apparatus according to claim 9, wherein the processor is further configured to:
configure a quality class identification (QCI) corresponding to the signaling bearer according to the attach request and at least one of:
a QCI corresponding to a real-time game service;
a QCI corresponding to an inter-vehicle communication service; or
a predefined first QCI, the first QCI being the QCI of a service quality of the signaling bearer established for the controllable device.

11. The apparatus according to claim 10, wherein a service quality parameter corresponding to the first QCI comprises at least one of:
a type that is a resource type having guaranteed bit rate;
a packet delay budget within a delay scope ranging from 50 milliseconds to 100 milliseconds; or
a packet loss rate ranging from 10⁻⁴ to 10⁻³.

12. The apparatus according to claim 10, wherein the processor is further configured to:
add a target note into the QCI corresponding to the signaling bearer, the target note being used to identify that the current QCI is used to transmit information corresponding to the controllable device.

13. The apparatus according to claim 9, wherein the processor is further configured to:
configure a quality class identification (QCI) corresponding to the data bearer according to the attach request and a predefined second QCI, the second QCI being a QCI of a service quality of the data bearer established for the controllable device.

14. The apparatus according to claim 13, wherein a service quality parameter corresponding to the second QCI comprises at least one of:
a type that is a resource type having guaranteed bit rate or non-guaranteed bit rate;
a packet delay budget within a delay scope ranging from 100 milliseconds to 300 milliseconds; or
a packet loss rate ranging from 10⁻⁶ to 10⁻⁵.

15. The apparatus according to claim 13, wherein the processor is further configured to:
add a target note into the QCI corresponding to the data bearer, the target note being used to identify that the current QCI is used to transmit information corresponding to the controllable device.

16. The apparatus according to claim 9, wherein the controllable device is an unmanned aerial vehicle.

17. A communication system implementing the method of claim 1, comprising the controllable device and the core network, wherein:
the controllable device is configured to initiate the attach request to the core network in the cellular network after the boot operation is completed; and
the core network in the cellular network is configured to separately establish a dedicated bearer for signaling and data of the controllable device, thereby ensuring that the controllable device is attached to the core network in the cellular network, and ensuring that the signaling and data of the controllable device are transmitted in the cellular network with improved communication quality of the cellular network.

18. The communication system of claim 17, wherein:
the core network is configured to establish a QCI corresponding to the signaling bearer for the controllable device according to the attach request and at least one of: a QCI corresponding to a real-time game service; a QCI corresponding to an inter-vehicle communication service; or a predefined first QCI, wherein the first QCI is the QCI of a service quality of the signaling bearer established for the controllable device.

19. The communication system of claim 17, wherein:
the core network is configured to configure a QCI corresponding to the signaling bearer for the controllable device according to the attach request and a predefined second QCI; and
the second QCI is a QCI of a service quality of the data bearer established for the controllable device.

20. The communication system of claim 19, wherein:
the core network in the cellular network is configured to separately add a target note into the QCI corresponding to the signaling bearer and the QCI corresponding to the data bearer;
the target note configured to identify that the current QCI is used to transmit information corresponding to the controllable device;
the current QCI is allowed to transmit the information corresponding to the controllable device, and then the QCI corresponding to the signaling bearer and the QCI corresponding to the data bearer are configured to be separately configured by the QCI into which the target note is added, thereby improving service quality for the signaling communication and the data communication between the cellular network and the controllable device; and
the controllable device is an unmanned aerial vehicle.
